(19) United States
(12) Patent Application Publication
(10) Pub. No.: US 2018/0052321 A1
(43) Pub. Date: Feb. 22, 2018

(54) LIGHT-SENSING HEADS-UP DISPLAY WITH REFLECTIVE AND EMISSIVE MODES

(71) Applicant: Xiaohui Kong, Chicago, IL (US)

(72) Inventor: Xiaohui Kong, Chicago, IL (US)

(21) Appl. No.: 15/559,818

(22) PCT Filed: Mar. 26, 2016
(86) PCT No.: PCT/US16/24379

§ 371 Date: Sep. 19, 2017

Related U.S. Application Data
(60) Provisional application No. 62/143,043, filed on Apr. 4, 2015.

(51) Int. Cl. G02B 27/01; G09G 3/00

(52) U.S. Cl. CPC G02B 27/01; G09G 3/001; G09G 2380/10; G09G 2360/141; G09G 2360/144; G09G 2300/0456

(57) ABSTRACT

A light-sensing heads-up display device for automobiles is provided with an emissive mode and a reflective mode. The emissive mode is activated when an ambient light sensor detects the vehicle is operating in relative darkness. The reflective mode is activated when ambient light sensor detects the vehicle is operating in relatively bright light. Emissive mode uses a video display to project reversed navigational data which is then seen in mirror image on a driver's windshield. Reflective mode uses external sunlight to reflect reversed navigational data from white particles in an e-ink display, which is then seen in mirror image on a driver's windshield. Light-sensing heads-up display device communicates wirelessly with a smartphone or navigation device to receive navigation data and may be operated by voice command. Cognitive display methods translate received navigation data for minimal distraction.

### CROSS-REFERENCE TO RELATED APPLICATION

This application claims priority under 35 U.S.C. §119(e) from U.S. Provisional Patent Application No. 62/143,043, by Kong, “Vehicle Head-Up Display System Utilizing Electronic Paper Display”, filed Mar. 4, 2015, which is incorporated by reference for all purposes.

### TECHNICAL FIELD

The present invention relates generally to computerized vehicle navigation devices. More particularly, the present invention relates to heads-up display devices for vehicles that use a reflective informational module to create a windshield navigational display when used in bright sunlight.

### BACKGROUND ART

It is an object of the present invention to provide a new and improved technique to provide a vehicle heads-up display system with low power consumption and high visibility in bright sunlight. Attempts at projecting a heads-up display onto the interior of a windshield using standard consumer displays, such as LED or LCD screens, are insufficient to overcome the backlighting of a bright sunny day. Further, attempting to overcome bright daylight with powerful LED projection results in excessive power consumption. A more elegant method of providing vehicle heads-up display in any external lighting condition is sought.

### DISCLOSURE OF INVENTION

A light-sensing heads-up display device for vehicles uses a light sensor to determine when to switch between an emissive mode and a reflective mode. The reflective mode is activated when ambient light sensor detects the vehicle is operating in relatively bright light. The emissive mode is activated when the ambient light sensor detects the vehicle is operating in relative darkness.

Because the light-sensing heads-up display device sits on the dashboard of a vehicle, its ambient light sensor determines the intensity of light falling onto to the device through the vehicle windshield, and thus the intensity of backlighting to any heads-up display on the windshield interior. When a windshield brightness trigger event occurs, meaning the light intensity is high enough to indicate that a heads-up up display projected onto to the windshield interior would be more visible using the reflective mode rather than the emissive mode, reflective mode is activated.

Reflective mode uses an electronic paper layer to display navigational data on the face of the device. Highly reflective white particles in the electronic paper layer form the letters and images making up the navigational display data, while non-reflective black particles in the electronic paper layer make up the background or negative space of the navigational display.

Thus, bright external sunlight, which would overpower light from an LED screen, is made to reflect the navigational display data from the face of the light-sensing heads-up display device. The navigational display data is thereby reflected onto the windshield interior, with brightness comparable to the bright exterior daylight. The navigational display in the electronic paper layer of the device is, naturally, shown in reverse to compensate for its mirroring on the vehicle windshield.

Because the electronic paper layer uses power only when moving an electronic ink particle, and not to continuously project light, the heads-up display device can run for weeks on an internal battery. Further, electronic paper reflection allows for high contrast, low display jitter and minimal screen redraw.

Sitting below the electronic paper layer, a video layer provides reversed navigational display output when a windshield darkness trigger event is detected by the ambient light sensor. This means the sensed ambient light intensity is low enough to indicate that a heads-up up display projected onto to the windshield interior would be more visible using the emissive mode rather than the reflective mode, as might occur when a vehicle is operating at night, in a tunnel, or on a cloudy day. The video layer is a backlit or sidelit LED layer or LCD layer, or any other light-emitting consumer display capable of fitting into a dashboard device.

Emissive mode uses the video layer to project reversed navigational data, which is then seen in mirror image on a driver's windshield. As with the reflective mode, the navigational display data is shown in bright or white, with the background or negative space left as darkened areas of the LED layer. In order to allow the LED light through, the electronic paper layer above it can be made nearly transparent by scattering its particles or stacking them vertically.

Light-sensing heads-up display device receives mapping and other navigation display data and control wirelessly from a smartphone running heads-up display control software. The control software can provide navigation data, such as turns, distances and street names, as well as related information like local speed limits and road conditions.

Cognitive visual-spatial display methods incorporated into the control software arrange the textual and graphic elements of the display so as to maximize communication of information with minimize visual distraction to the driver. Further, the control software running on a smartphone or similar device handles voice commands, such that a driver can control the heads-up display without hands leaving the steering wheel.

Other methods and structures are described in the detailed description below. This summary does not purport to define the invention. The invention is defined by the claims.

### BRIEF DESCRIPTION OF DRAWINGS

FIG. 1 is a perspective view of an automobile interior showing placement of a light-sensing heads-up display device and a smartphone in accordance with an embodiment of the invention.

FIG. 2 is a face view of a light-sensing heads-up display device, unpowered.

FIG. 3 is a front face view of a light-sensing heads-up display device, powered and operating in a reflective mode.

FIG. 4 is a stylized view of the heads-up display information showing on a glass background, based on the view of FIG. 3.

FIG. 5 is a front face view of a light-sensing heads-up display device, powered and operating in an emissive mode.

FIG. 6 is a stylized view of the heads-up display information showing on a darkened glass background, based on the view of FIG. 5.

FIG. 7 is a stylized view showing the light-sensing heads-up display device edge-on and heads-up display information on a night-time vehicle windshield.

FIG. 8 is a stylized cross-section view showing the arrangement of reflective display module and emissive display module according to the preferred embodiment.

FIG. 9 is a stylized cross-section view showing an emissive display module in use.

### BEST MODE FOR CARRYING OUT INVENTION

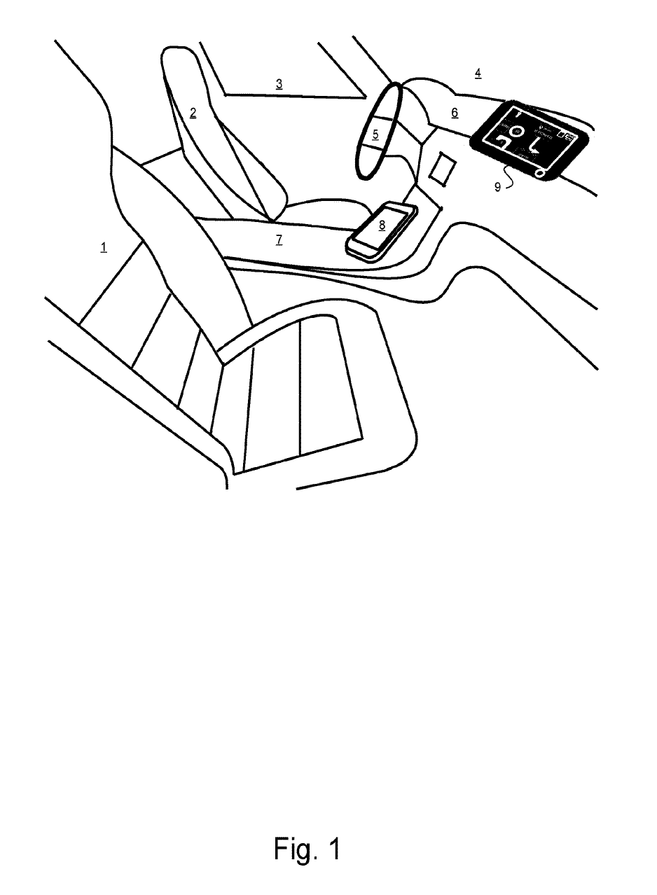

FIG. 1 is a perspective view of an automobile interior showing placement of a light-sensing heads-up display device and a smartphone in accordance with a preferred embodiment of the invention.

The automobile interior view is bounded by a passenger seat 1, driver's seat 2, driver side window 3 and windshield 4. Interior surfaces labelled in the automobile interior view include the steering wheel 5, dashboard 6 and center console 7.

Resting on the center console 7 is a smartphone 8. Said smartphone 8 may be of any type or brand capable of running navigational software and capable of a device-to-device communication method such as Bluetooth, allowing the smartphone to communicate navigation data wirelessly to the light-sensing heads-up display device 9 that rests on the dashboard 6 of an automobile.

The back of the light-sensing heads-up display device 9 is affixed to the dashboard 6 of the vehicle by typical methods, such as suction cup or hook-and-loop patch to prevent sliding out of place. Thus, when placed on the dashboard of a typical automobile with a slanted windshield, the face of the light-sensing heads-up display device 9 is within a ninety-degree arc of the windshield interior.

The face of the light-sensing heads-up display device 9 is thus reflected on the interior surface of the windshield 6. Navigation data transmitted wirelessly from the smartphone 7 is filtered and translated via software on-board the light-sensing heads-up display device 9 remove extraneous or distracting information and maximize readability.

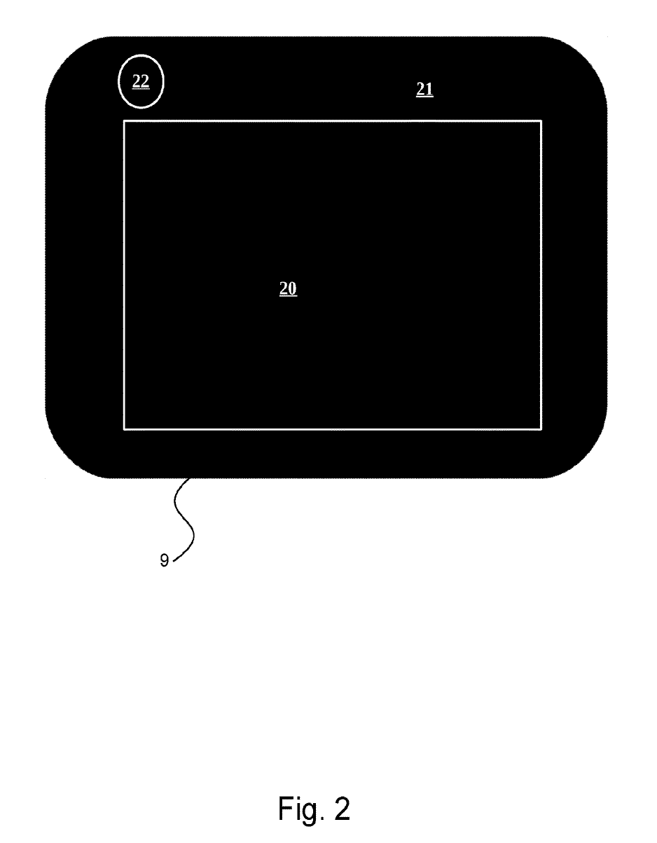

FIG. 2 is a front face view of the light-sensing heads-up display device 9 of FIG. 1, unpowered. The screen 20 of the device is shown darkened and displaying no data. Surrounding the screen 20 is a border portion 21, typically plastic with, in the preferred embodiment, a matte finish to minimize reflection. A beveled edge may also be employed for the border portion.

Also located on the face of the device, within the border portion 21, is an ambient light sensor 22. Surface of ambient light sensor 22 is at least parallel with the surface of the screen 20 in the preferred embodiment, or may be angled toward the surface of the screen in order to face ambient sunlight emanating from near the horizon. Ambient light sensor 22 may be co-planar with screen 20, or may be simply parallel without being co-planar.

Because of its purpose as a vehicle windshield display device, the light-sensing heads-up display device 9 is operated entirely by electronic or voice s. An internal control circuit handles included functions, such as electronic communication with external devices and control of electronic paper layer, video layer and ambient light sensor. For this reason, FIG. 1 indicates that there are no push-buttons, touch-screens, scroll-wheels or other touch controls on the device. This means that the light-sensing heads-up display device 9 is characterized as neither featuring nor using touch controls.

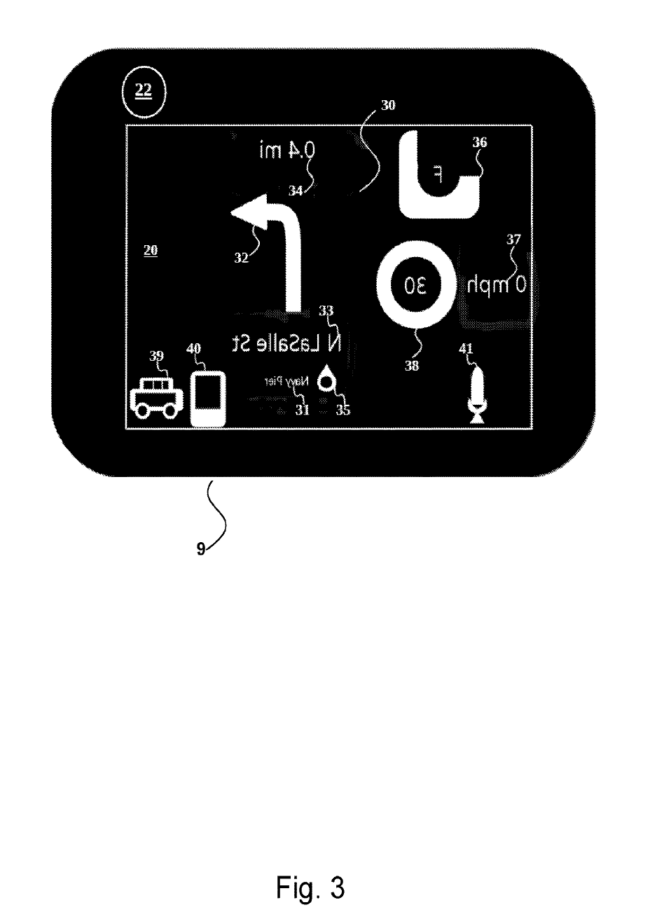

FIG. 3 is a front face view of a light-sensing heads-up display device 9, powered and operating in a reflective mode. In reflective mode, screen 20 employs an electrophoretic layer of electrically charged black and white pigments to produce black, white and grayscale displays, as according to electrophoretic display brands E-Ink or SiPix. Other electronic paper technologies, such electrowetting or electrofluidic, can be used but are considered less effective at presenting a reflection with clear, sharp edges.

Reflective mode is activated when light-sensing heads-up display device 9 senses a windshield brightness trigger event via ambient light sensor 22, which means that light intensity sensing indicates persistent daylight brightness behind the windshield 4 too bright for a video display to be effective. For example, light intensity measured in lux is considered equivalent to full daylight in the range of 10,000 to 32,000 lux. Thus, in the preferred embodiment, a windshield brightness trigger event occurs at 10,000 lux as sensed by the ambient light sensor 22. Alternate embodiments may set the windshield brightness trigger event as high as 32,000 lux or as low as 8,000 lux.

In reflective mode, reflective mode screen display 30 is presented using white electronic ink particles and screen 20 areas empty of display data are left darkened using black electronic ink particles. Reflective mode screen display 30 is characterized as being presented backwards, in reverse from normal orientation for reading. Reflective mode screen display 30 can include destination 31, directional turn arrow 32, next street 33, distance to next turn 34 and destination pointer 35. Reflective mode screen display 30 can also show auxiliary driving information including fuel gauge 36, speed 37 and local speed limit 38. Operational status including automobile connection 39, smartphone connection 40 and microphone status 41 can also be shown as part of reflective mode screen display 30.

Bright sunlight shining through the windshield is thus reflected from the reflective electronic ink particles of the reflective mode screen display 30 to appear visible to a driver, in mirror image on the windshield. This means that reflective mode screen display 30 is characterized by presenting information, such as text or graphics, optimized for reflectivity and by presenting background or negative display portions as optimized for minimal reflectivity.

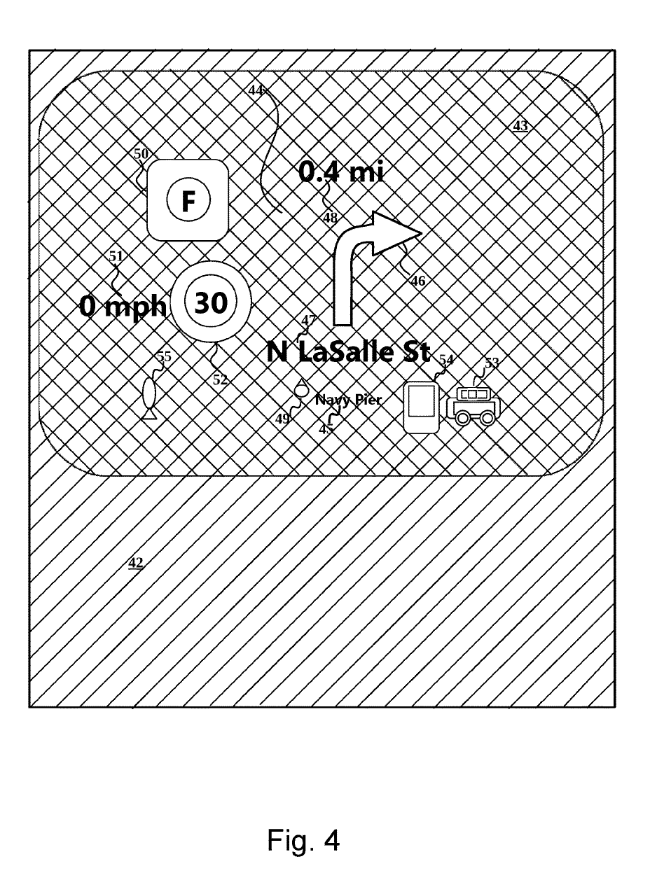

FIG. 4 is a stylized view of the heads-up display information showing on a stylized glass background 42, based on the view of FIG. 3. Daylight reflected minimally from black or non-reflective electronic ink particles in the display screen produce a translucent and minimally apparent reflection area on the glass 43. Daylight reflected maximally from white or reflective electronic ink particles in the display screen produce a bright display of information with clear, sharp edges and no flicker.

Navigational data on the windshield is thus reflected into proper orientation as reflective mode windshield display 44 and can include destination 45, directional turn arrow 46, next street 47, distance to next turn 48 and destination pointer 49. Reflective mode windshield display 44 also shows auxiliary driving information including fuel gauge 50, velocity 51 and local speed limit 52. Operational status including automobile wireless connection 53, smartphone wireless connection 54 and microphone status 55 are also shown as part of reflective mode windshield display 44.

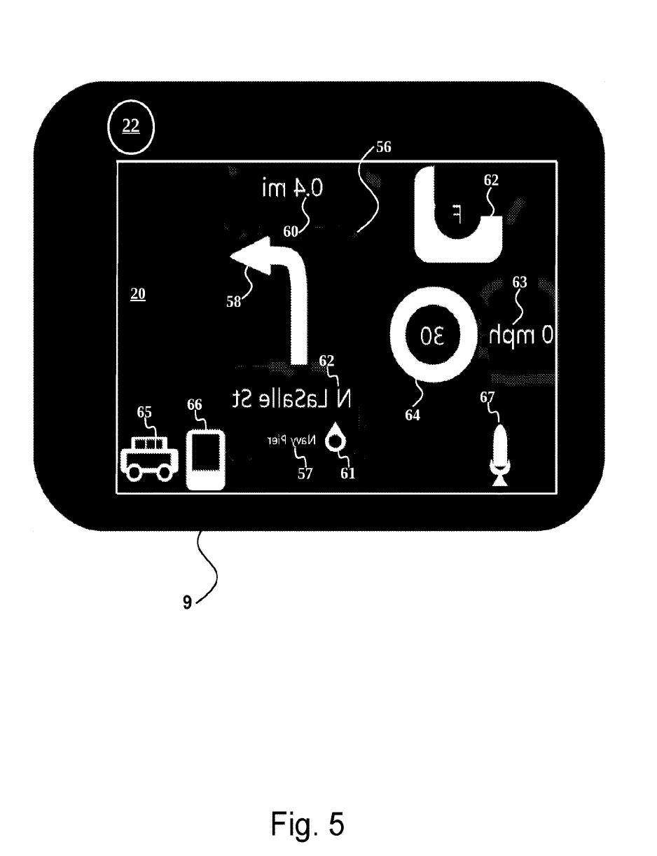

FIG. 5 is a front face view of a light-sensing heads-up display device 9, powered and operating in an emissive mode. In the preferred embodiment, screen 20 employs a backlit LED matrix to produce a night-time navigational display.

Emissive mode is activated when light-sensing heads-up display device 9 senses a windshield darkness trigger event via ambient light sensor 22, which means that ambient light sensing indicates persistent dimness or night behind the windshield 4 too dark for a reflective display to be effective. For example, light intensity measured in lux is considered equivalent to indoor lighting when under 10,000 lux. Thus, in the preferred embodiment, a windshield darkness trigger event occurs at 10,000 lux or less sensed by the ambient light sensor 22 when sensing over that trigger level previously. Alternate embodiments may set the windshield darkness trigger event as high as 32,000 lux or as low as 8,000 lux.

In emissive mode, emissive mode screen display 56 is presented using brightly lit portions of a video display module of the screen 20 and null areas of empty of display data are left darkened as dark areas of the video display module. The video display can be triggered to a simple on or off by the windshield darkness trigger event, but the preferred embodiment of the invention sets the brightness of the video display to inverse correlation with the brightness sensed by ambient light sensor 22.

Emissive mode screen display 56 is characterized by being presented reversed and can include destination 57, directional turn arrow 58, next street 59, distance to next turn 60 and destination pointer 61. Emissive mode screen display 56 can also show auxiliary driving information including fuel gauge 62, speed 63 and local speed limit 64. Operational status including automobile wireless 65, smartphone wireless 66 and microphone status 67 can also be shown as part of emissive mode screen display 56.

Because there is no or little sunlight shining through the windshield 4, light emitted from the emissive display module of the screen as reversed emissive mode screen display 56 will appear in mirror image on the windshield.

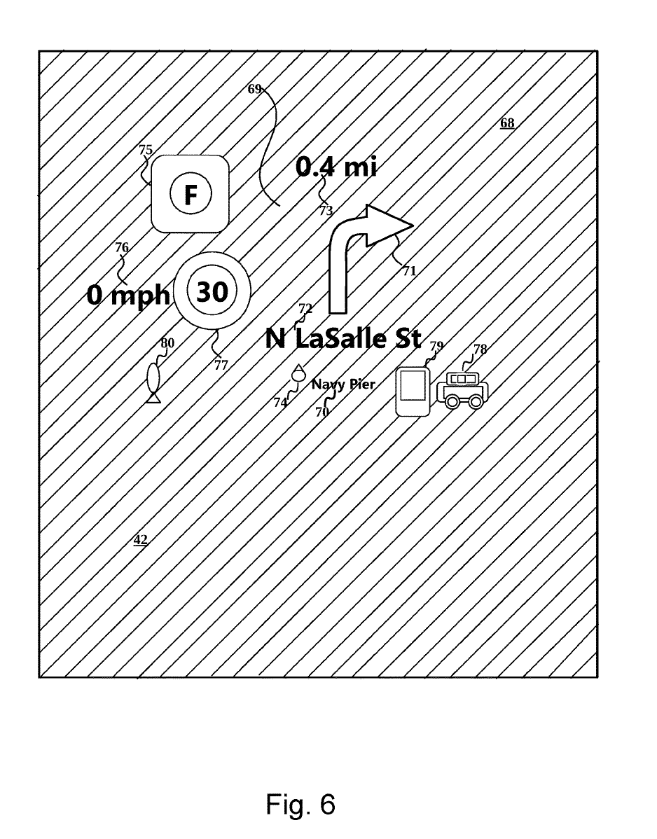

FIG. 6 is a stylized view of the heads-up display information showing on a stylized glass background 60, based on the view of FIG. 5. Edge portion of the light-sensing heads-up display device produces no light leaving an area of no reflection on glass. Darkened portions of emissive mode screen display produce a translucent and minimally apparent reflection area 68 on the glass. Brightly lit pixels of the emissive display screen produce a bright display of navigation information which contrast with the exterior darkness.

Navigational data on the windshield is thus reflected into proper orientation as emissive mode windshield display 69 and can include destination 70, directional turn arrow 71, next street 72, distance to next turn 73 and destination pointer 74. Emissive mode windshield display 69 also shows auxiliary driving information including fuel gauge 75, velocity 76 and local speed limit 77. Operational status including automobile wireless connection 78, smartphone wireless connection 79 and microphone status 80 is also included in emissive mode windshield display 69.

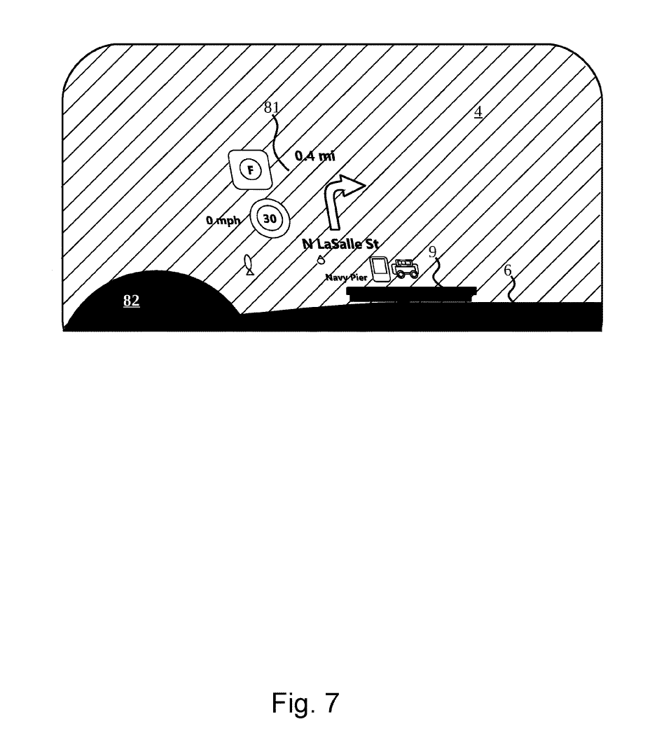

FIG. 7 is a stylized view showing the light-sensing heads-up display device 9 edge-on and heads-up navigational display information 81 on a vehicle windshield 4.

According to the preferred embodiment, light-sensing heads-up display device 9 is shown laying flat on vehicle dashboard 6 and secured using adhesive means, as described above in regard to FIG. 1. However, in alternate embodiments, the light-sensing heads-up display device 9 may have a shape that angles the face of the device toward the windshield, or the adhesive means may similarly tilt the face of the device toward the windshield.

Light-sensing heads-up display device 9 is typically placed just to the side of the driver's steering display portion 82 of the dashboard 6. This places the heads-up navigational display information 81 near but not directly in the driver's line of sight. Placing the light-sensing heads-up display device 9 to the side of, rather than behind, the steering wheel allows ease in removing and replacing the light-sensing heads-up display device 9 when leaving the vehicle.

Thus, the light-sensing heads-up display device 9 is configured to lay flat or nearly flat on the windshield. Due to variations in angle of outside light, device placement and windshield curvature heads-up navigational information 81 may display with slight distortions, demonstrated in the figure. These distortions may include mild rotation, shearing or distortions of perspective but are not enough to distract or to obscure the heads-up navigational display information 81.

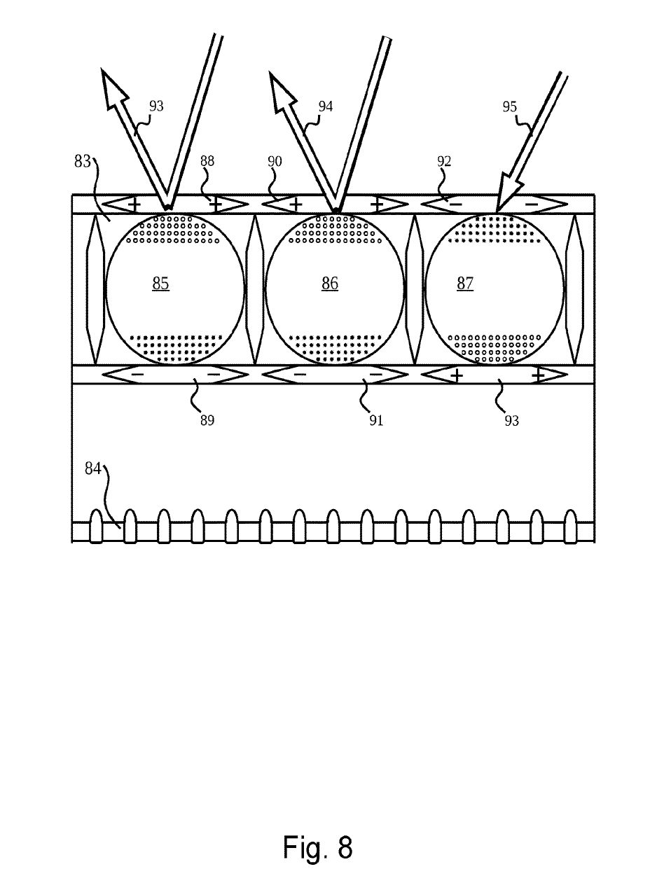

FIG. 8 is a stylized cross-section view showing the arrangement of reflective display module and emissive display module according to the preferred embodiment. Reflective display module 83 is in use and is shown as a layer of transparent microcapsules sandwiched between transparent layers of chargeable elements.

A first microcapsule 85, in this example, is filled with negatively charged bright, reflective electronic ink particles and positively charged dark, non-reflective electronic ink particles suspended in a liquid. When positive charge is applied to upper chargeable element 88, the reflective particles are attracted to the upper surface of the microcapsule 85, just as the non-reflective particles are attracted to the lower surface when a negative charge is applied to lower chargeable element 89. Second microcapsule 86 is arranged the same way, using positively charged element 90 and negatively charged element 91.

Third microcapsule 87 is arranged in the obverse manner. A negative charge is applied to upper chargeable element 92 so that the non-reflective particles are attracted to the upper surface of the microcapsule 87, just as the reflective particles are attracted to the lower surface by a positive charge applied to lower chargeable element 93.

Therefore, first lightbeam 94 striking first microcapsule 85 and second lightbeam 95 striking second microcapsule 86 are strongly reflected back toward a vehicle windshield. Third lightbeam 96, however, strikes third microcapsule 87 and is not reflected. The face of the device above the cross-section view of FIG. 8 therefore appears to have two bright and one dark pixel, and the bright, reflective pixels are used to make up the reversed text or reverse graphical elements of a reflective mode screen display.

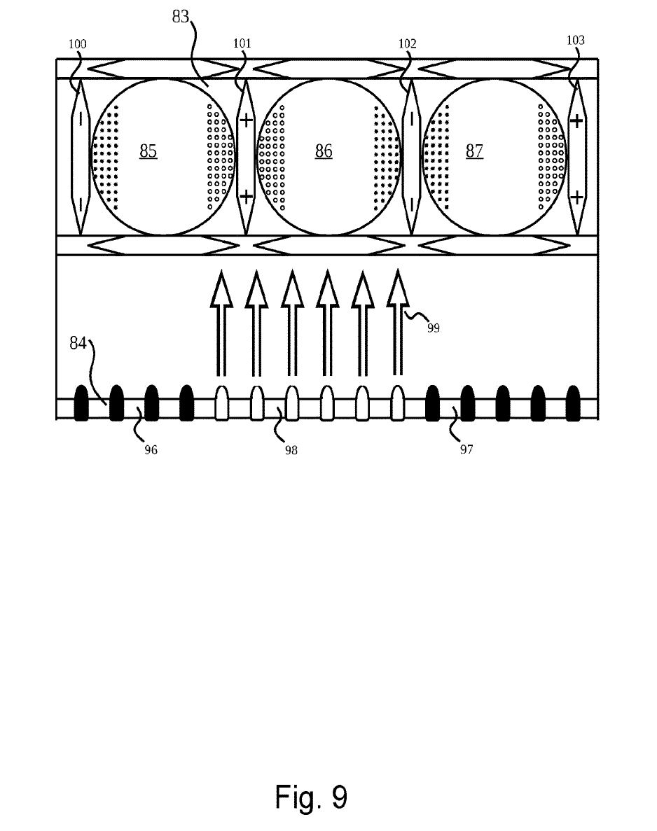

FIG. 9 is the stylized cross-section view according to FIG. 8, but showing emissive display module 84 in use. Emissive display module is thin, light-emitting layer of any type useable for video displays. In the preferred embodiment, the emissive display module is an LED screen. A first bank of LED elements 96 and a second bank of LED elements 97 are shown darkened. A third bank of LED elements 98 in the emissive display module 84 is activated and emitting light 99.

Above, the reflective display module is put into a transparent mode by the control circuit. In transparent mode, the reflective display module is made transparent, partially transparent or translucent by moving the charged electronic ink particles aside and stacking them vertically. Vertical elements 100 and 102 are negatively charged, attracting the non-reflective electronic ink particles. Vertical elements 101 and 103 are positively charged, attracting the reflective electronic ink particles.

The electronic ink particles in the transparent microcapsules are thus arranged to cause little or no obstruction to passage of light emitted from the emissive display module 84. The face of the device above the cross-section view of FIG. 9 therefore appears to have two dark pixels 96 and 97 and one bright pixel 98. The bright pixels are used to make up the reversed text or reverse graphical elements of an emissive mode screen display.

It is noted that the described method of making the electronic paper layer transparent is not the only method known in the art. It is, for example, possible to move the microcapsules containing electronic ink pigments or to decohere the pigments by applying heat or voltage to the suspending liquid. The invention also contemplates making use of variable and partial transparency levels possible with electronic ink.

Note that the depicted shape of any aspect of the heads-up navigational display information is not the only possible shape. In some embodiments, the ambient light sensor may be a rectangular or square rather than a circle or oval. In over the road vehicles or those with vertical windshields or minimal dashboard space, the device may be secured in place using other methods, such as a set of L-brackets. Control software can run on devices other than a smartphone, such as a vehicle's on-board computer, a dedicated navigation device, or on the heads-up display device itself. Positive and negative charges of electronic ink elements can, depending on the implementation, be different from the examples shown in FIG. 8 and FIG. 9. It is contemplated that light emitters for the emissive layer may be arranged other than below the reflective layer. And, while wireless communication between the heads-up display is described as using “Bluetooth”, other wireless protocols are possible.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A vehicle heads-up display device, comprising:
an emissive display module;
a reflective display module; and,
a control circuit which causes said emissive display module to produce an emissive mode screen display in response to a windshield darkness trigger event and which causes said reflective display module to produce a reflective mode screen display in response to a windshield brightness trigger event.

2. The vehicle heads-up display device of claim 1, wherein said reflective mode screen display comprises visually reversed navigational data.

3. The vehicle heads-up display device of claim 1, wherein said reflective mode screen display comprises navigational data reflection-optimized such that navigational data text and images are displayed using white or light screen elements and such that neutral space is displayed using black or dark screen elements.

4. The vehicle heads-up display device of claim 1,
wherein said reflective display module comprises an electronic paper layer; and,
wherein said emissive display module comprises an LED layer.

5. The vehicle heads-up display device of claim 1,
wherein said reflective mode screen display is optimized for driver cognitive efficiency.

6. The vehicle heads-up display device of claim 1, further comprising:
an ambient light sensor situated on the face of the vehicle heads-up display device that senses a windshield brightness trigger event and a windshield darkness trigger event.

7. The vehicle heads-up display device of claim 1, further comprising:
an ambient light sensor that senses a windshield brightness trigger event of 10,000 lux or greater and a windshield darkness trigger event of 10,000 lux or lower.

8. The vehicle heads-up display device of claim 1,
wherein said reflective display module uses maximally reflective e-paper elements to present navigational data.

9. The vehicle heads-up display device of claim 1, wherein said reflective display module uses electrically charged reflective particles to present text.

10. The vehicle heads-up display device of claim 1, wherein said reflective display module uses microencapsulated electrophoretic particles to present navigational data; and,
wherein said reflective display module uses minimally reflective e-paper elements to present negative space.

11. The vehicle heads-up display device of claim 1,
wherein said reflective display module and said emissive display module are arranged as fixed, immovable layers;
wherein said reflective display module is arranged on top of said emissive display module when the vehicle heads-up display device is resting face up; and,
wherein said reflective display module is an e-paper display that enters a transparent mode when said emissive display module is activated.

12. The vehicle heads-up display device of claim 1, said vehicle heads-up display device having no touch-screen controls and being operable without touch controls.

13. The vehicle heads-up display device of claim 1,
wherein said reflective mode screen display comprises navigational data received electronically from an external device;
wherein said control circuit sends information as to the state of said reflective display module and said emissive display module to an external device electronically; and,
wherein said control circuit receives voice control signals electronically from an external device.

14. The vehicle heads-up display device of claim 1,
wherein said reflective display module comprises an electronic paper layer fixed immovably above said emissive display module with the vehicle heads-up display device facing upward;
wherein said emissive display module comprises an LED layer; and,
wherein said reflective mode screen display comprises visually reversed navigational data.

15. The vehicle heads-up display device of claim 1,
wherein said reflective display module comprises an electronic paper layer fixed immovably above said emissive display module with the vehicle heads up display device facing upward;
wherein said emissive display module comprises an LED layer;
wherein said reflective mode screen display comprises visually reversed navigational data; and,
wherein said reflective mode screen display comprises opaque neutral space optimized for minimal reflectivity.

16. The vehicle heads-up display device of claim 1,
wherein said reflective display module comprises an electronic paper layer fixed immovably above said emissive display module with the vehicle heads up display device facing upward;
wherein said emissive display module comprises an LED layer;
wherein said reflective mode screen display comprises visually reversed navigational data; and,
wherein said reflective mode screen display comprises opaque neutral space optimized for minimal reflectivity;
wherein said reflective mode screen display comprises navigational data received electronically from an external device;
wherein said control circuit sends information as to the state of said reflective display module and said emissive display module to an external device electronically; and,
wherein said control circuit receives voice control signals electronically from an external device,
said vehicle heads-up display device having no touch-screen controls.

17. The vehicle heads-up display device of claim 1,
wherein said reflective display module comprises an electronic paper layer fixed immovably above said emissive display module with the vehicle heads up display device facing upward;
wherein said emissive display module comprises an LED layer;
wherein said reflective mode screen display comprises visually reversed navigational data that is optimized for driver cognitive efficiency;
wherein said reflective mode screen display comprises opaque neutral space optimized for minimal reflectivity;
wherein said reflective mode screen display comprises navigational data received electronically from an external device;
wherein said control circuit sends information as to the state of said reflective display module and said emissive display module to an external device electronically; and,
wherein said control circuit receives voice control signals electronically from an external device;
said vehicle heads-up display device having no touch-screen controls;
said vehicle heads-up display device further comprising an ambient light sensor located on the face of the vehicle heads-up display device; and,
said vehicle heads-up display device being attachable to and detachable from a vehicle dashboard.

18. The vehicle heads-up display device of claim 1,
wherein said reflective display module uses electrophoretic particles to present navigational data; and,
wherein said reflective display module enters a transparent mode by moving electrically charged electronic ink particles aside.

19. A method of presenting heads-up navigational display data on a vehicle windshield, comprising:
sensing a windshield brightness trigger event using an ambient light sensor;
activating a reflective display layer in response to said sensing of a windshield brightness trigger event;
receiving a first set of navigational data from an external device;
displaying said first set of navigational data using reflective elements of said reflective display layer;
sensing a windshield darkness trigger event using an ambient light sensor;
setting said reflective display layer to a substantially transparent state in response to said sensing of a windshield darkness trigger event;
activating an emissive display layer in response to said sensing of a windshield darkness trigger event;
receiving a second set of navigational data from said external device; and,
displaying said second set of navigational data using light-emitting elements of said emissive display layer.

20. A vehicle heads-up display device, comprising:
an ambient light sensor that senses a windshield brightness trigger event and a windshield darkness trigger event;
a reflective display module comprising an electronic paper layer that uses white or light electronic paper elements to display text and images and black or dark electronic paper elements to display negative space surrounding text and images;
an emissive display module comprising an LED layer, said emissive display module being fixed below the reflective display module with the vehicle heads up display device facing upwards;
and,
a control circuit,
said control circuit causing said emissive display module to produce an emissive mode screen display in response to a windshield darkness trigger event, said emissive mode screen display comprising visually reversed navigational data;
said control circuit causing said reflective display module to produce a reflective mode screen display in response to a windshield brightness trigger event; and,
said control circuit causing said reflective display module to enter a transparent mode when said emissive display module is activated;
wherein said reflective mode screen display comprises visually reversed navigational data;
wherein said reflective mode screen display also comprises reflection-optimized navigational data;
wherein said reflective mode screen display also comprises neutral space optimized for minimal reflectivity;
wherein said control circuit receives voice control signals electronically via vehicle heads-up display software running on an external device;
wherein said control circuit receives visually reversed navigational data electronically via said vehicle heads-up display software running on an external device in real time; and,
wherein said control circuit sends information as to the state of said reflective display module and said emissive display module to said vehicle heads-up display software running on an external device electronically.
